(19) United States
(12) Patent Application Publication
(10) Pub. No.: US 2010/0145991 A1
(43) Pub. Date: Jun. 10, 2010

(54) Method and Apparatus to Facilitate Selecting a Particular Rendering Method

(75) Inventors: Mark A. Gannon, Sleepy Hollow, IL (US); Wayne W. Ballantyne, Coconut Creek, FL (US); Louis J. Lundell, Buffalo Grove, IL (US); Steven J. Nowlan, South Barrington, IL (US); Louis J. Vannatta, Crystal Lake, IL (US)

Correspondence Address: MOTOROLA/FETF, 120 SOUTH LASALLE STREET, SUITE 1600, CHICAGO, IL, 60603-3406, US

(73) Assignee: MOTOROLA, INC., Schaumburg, IL (US)

(21) Appl. No.: 12/331,085

(22) Filed: Dec. 9, 2008

(51) Int. Cl. G06F 17/30

(52) U.S. Cl. 707/781; 707/E17.032

(57) ABSTRACT

These various embodiments are suitable for use with a personally portable apparatus (200) that is configured and arranged to render selected content into a perceivable form for an end user of that personally portable apparatus. These teachings generally provide for gathering (101) information regarding this end user (wherein this information does not simply comprise specific instructions to the personally portable apparatus via some corresponding user interface). These teachings then provide for inferring (103) from this information a desired end user rendering modality (that is, as desired by that end user) for the selected content and then automatically selecting (105), as a function (at least in part) of that desired end user rendering modality, a particular rendering method from amongst a plurality of differing candidate rendering methodologies to employ when rendering the selected content perceivable to the end user at the personally portable apparatus.

### TECHNICAL FIELD

This invention relates generally to the selection of a particular content rendering method from amongst a plurality of differing candidate rendering methodologies.

### BACKGROUND

End-user platforms of various kinds are known in the art. In many cases these end-user platforms have a user output that serves, at least in part, to render content perceivable to the end user. This can comprise, for example, rendering the content audible, visually observable, tactilely sensible, and so forth. Increasingly, end-user platforms are also known that offer a plurality of differing rendering approaches. For example, some end-user platforms may be capable of presenting a visual display of text that represents the content in question and/or an audible presentation of a spoken version of that very same text. Such rendering agility may manifest itself in a variety of ways. The number of total rendering options available in a given end-user platform can range from only a few such options to many dozens or even potentially hundreds of such options.

Unfortunately, the expansion of such rendering capabilities has not necessarily led in every instance to increasingly satisfied users. In some cases, the reasons behind such dissatisfaction can be almost as numerous as the number of rendering options themselves. Generally speaking, however, the applicant has determined that such dissatisfaction can be viewed as deriving from at least the problems and confusion that a given end user might face when selecting a particular rendering method to use with a given item of content and also with the follow-on problem of later determining that the selected rendering method is, for whatever reason, no longer as effective a choice.

### BRIEF DESCRIPTION OF THE DRAWINGS

The above needs are at least partially met through provision of the method and apparatus to facilitate selecting a particular rendering method described in the following detailed description, particularly when studied in conjunction with the drawings, wherein:

FIG. 1 comprises a flow diagram as configured in accordance with various embodiments of the invention; and

FIG. 2 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, these various embodiments are suitable for use with a personally portable apparatus that is configured and arranged to render selected content into a perceivable form for an end user of that personally portable apparatus. These teachings generally provide for gathering information regarding this end user (wherein this information does not simply comprise specific instructions to the personally portable apparatus via some corresponding user interface). These teachings then provide for inferring from this information a desired end user rendering modality (that is, as desired by that end user) for the selected content and then automatically selecting, as a function (at least in part) of that desired end user rendering modality, a particular rendering method from amongst a plurality of differing candidate rendering methodologies to employ when rendering the selected content perceivable to the end user at the personally portable apparatus.

The aforementioned information can be developed, if desired, through the use of one or more local sensors (that comprise a part, for example, of the personally portable apparatus). The aforementioned information can also be developed, if desired, by accessing one or more remote sensors (via, for example, some appropriate remote sensor interface). This information can comprise, for example, information regarding physical actions taken by the end user, information regarding a physical condition of the end user, and so forth.

These teachings will also readily accommodate incorporating and using other kinds of information to support the aforementioned selection activity. For example, by one approach, this can comprise gathering information regarding ambient conditions as pertain to the personally portable apparatus and/or information regarding a present state of the personally portable apparatus. This supplemental information can then be employed to further inform the automatic selection of a particular rendering method from amongst the plurality of differing candidate rendering methodologies.

Those skilled in the art will recognize and appreciate that these teachings can be readily used with a vast number of existing platforms of various kinds. This includes, for example, two-way wireless communications apparatuses. It will further be appreciated that, in many application settings, these teachings are usable without necessarily requiring significant hardware alterations to existing platform designs. These teachings are also highly scalable and can be employed to advantage with virtually any rendering modality and end-user purpose.

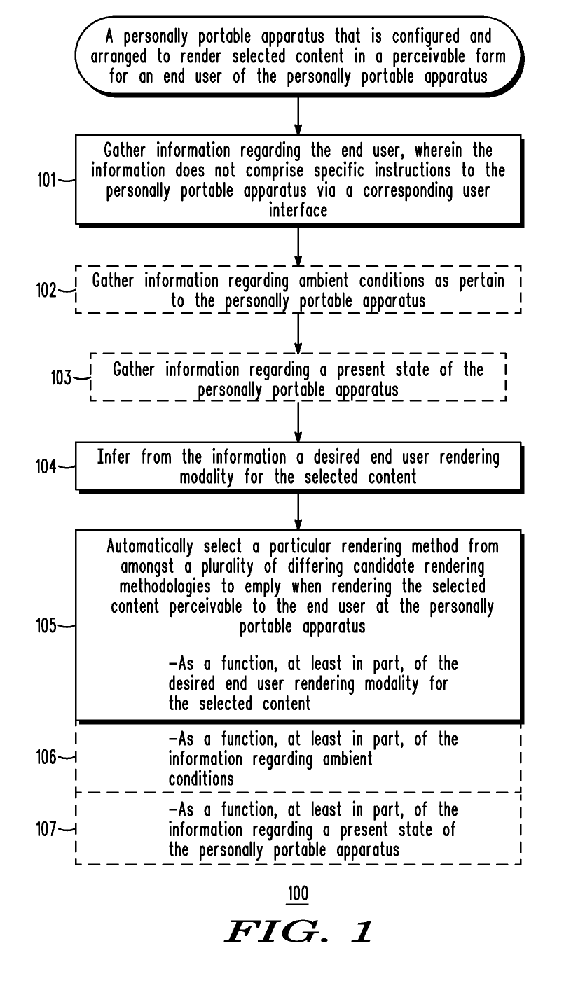

These and other benefits may become clearer upon making a thorough review and study of the following detailed description. Referring now to the drawings, and in particular to FIG. 1, an illustrative process that is compatible with many of these teachings will now be presented. For the purposes of this example a personally portable apparatus that is configured and arranged to render selected content in a perceivable form for an end user of the personally portable apparatus facilitates the described process 100. (As used herein, the expression “personally portable” shall be understood to refer to an apparatus that can be readily carried about and used for its intended purpose by a normal average adult human.) This can comprise, for example, a two-way wireless communications apparatus such as a cellular telephone, certain so-called personal digital assistants, a push-to-talk handset, and so forth. Those skilled in the art will recognize and understand that such examples are intended to serve only in an illustrative capacity and are not intended to comprise an exhaustive listing of all possibilities in this regard.

As noted above, this personally portable apparatus is able to render selected content in a perceivable form for an end user of the apparatus. Those skilled in the art will recognize and understand that the form of this selected content can and will vary with the needs and/or opportunities as tend to characterize the application setting. Examples in this regard include, but are not limited to, audio-visual content, visual-only content, and audio-only content.

This process 100 provides the step 101 of gathering information regarding the end user. Pursuant to these teachings this particular information does not comprise specific instructions to the personally portable apparatus as may have been entered via some corresponding user interface. For example, this information does not comprise an instruction to increase a listening volume for the selected content that the end user may have indicated by manipulation of a volume control button. As another example, this information does not comprise an instruction to increase the brightness of a display screen that the end user may have indicated by manipulation of a brightness control slider.

Although this gathered information does not comprise a specifically entered end-user instruction, this gathered information can comprise, if desired, information regarding one or more physical actions taken by the end user. Exemplary physical actions include, but are not limited to, rotating the personally portable apparatus by approximately 90 degrees or 180 degrees, placing the personally portable apparatus on a support surface such as a tabletop, a change of gait (such as walking, running, or the like), placing the personally portable apparatus in the end user's pocket, a lack of sensed motion for some predetermined period of time (such as a certain number of minutes), and so forth.

As another example in these regards, this gathered information can comprise, if desired, information regarding one or more physical conditions of the end user. Examples in this regard can include, but are not limited to, the end user's heart rate, body temperature, cognitive loading, posture, blood chemistry (for example, oxygen level), and so forth.

Those skilled in the art will recognize that such examples are provided for the sake of illustration and do not necessarily comprise an exhaustive listing of all such possibilities. Other kinds of information regarding the end user can be useful as well depending upon the application setting and the ability to gather such information in an accurate and timely manner.

Generally speaking, the aforementioned information regarding the end user can be gathered using one or more corresponding sensors. For example, a pedometer-style sensor can be used when seeking to gather information regarding the present gait, or a change in gait, for the end user. By one approach this sensor (or sensors) can comprise local sensors and hence comprise an integral part of the personally portable apparatus. By another approach, this sensor (or sensors) can comprise remote sensors that do not comprise an integral part of the personally portable apparatus. By one approach, the corresponding information can be gathered from remote sources (such as a corresponding server). (As used herein, the expression “remote” will be understood to refer to either a significant physical separation (as when two objects are each physically located in discrete, separate, physically separated facilities such as two separate building) or a significant administrative separation (as when two objects are each administered and controlled by discrete, legally- and operatively-separate entities).)

If desired, and as an optional approach, this process 100 will also provide the step 102 of gathering information regarding ambient conditions as pertain to the personally portable apparatus. (As used herein, this reference to “ambient” will be understood to refer to circumstances, conditions, and influences that are local to the apparatus.) Examples in this regard include, but are not limited to, temperature, location (as determined using Global Positioning System (GPS) information or any other location-determination method of choice), humidity, light intensity, audio volume and frequency, cognitive-loading events and circumstances, environmental odor, and so forth. Again, as desired, such information regarding ambient conditions can be gathered using one or more corresponding local and/or remote sensors and/or can be accessed using local and/or remote information stores as may be available and as appropriate.

Also if desired, and again as an optional approach, this process 100 will also provide the step 103 of gathering information regarding a present state of the personally portable apparatus. Examples in this regard can comprise, but are not limited to, a presently available supply of portable power, a state of operation as pertains to one or more rendering modalities, a ring/vibrate setting of the ringer, whether a given cover is opened or closed, and so forth. In many cases, such information can be gleaned by the apparatus by simply monitoring its own states of operation. If desired, however, specific sensors in this regard can also be employed.

This process 100 then provides the step 104 of inferring from the aforementioned information a desired end user rendering modality for the selected content. To be quite clear in this regard, this desired modality is “inferred” because, as was already mentioned above, the information gathered regarding the end user does not comprise specific end-user instructions and hence the gathered information inherently cannot provide specific requirements in this regard.

Some non-limiting examples will now be provided to assist with further illuminating this point.

By one approach, the gathered information can relate to a physical action taken by the end user. This might comprise, for example, information indicating that the end user changed from a walking gait to a running gait. In this example, while walking, the personally portable apparatus provided the end user with a graphically displayed version of selected content comprising textual material. When running, however, it can be more difficult to avert one's eyes from one's path in order to view such a display. In this case, then, one may infer that the end user would prefer to now receive an audible version of the selected content (as may be provided by the use of synthesized text-to-speech), or that the end user would prefer to terminate the textual feed altogether and to shut off both device audio and display outputs.

By another approach, the gathered information can relate to a physical condition of the end user. This might comprise, for example, information indicating the heart rate (i.e., pulse) of the end user. In this example, while exhibiting a heart rate indicative of an at-rest physical condition, the personally portable apparatus provides the end user with a graphically displayed version of selected content comprising textual material. Upon detecting a significantly increased heart rate, however, it can be reasonably inferred that the end user has possibly begun to engage in a more strenuous physical activity such as running. In this case, then, one may also infer that the end user would prefer to now receive an audible version of the selected content (as may again be provided by the use of synthesized text-to-speech).

In another example, the end user's cognitive loading can be inferred by sensing elements. For example, from background sounds, vibrations, and/or odors a reasonable inference may be made that the end user is in an automobile. Higher cognitive loading could then be inferred, as it may be likely the end user is the driver of the automobile. Then, the personally portable device could adapt its modality as per these teachings to be more effective by, for example, using only audible modalities.

Again, those skilled in the art will recognize that the foregoing examples are provided for illustrative purposes and are not offered with any intent to narrow the scope of these teachings.

This process 100 then provides the step 105 of automatically selecting, as a function at least in part of the desired end user rendering modality for the selected content (as was inferred in step 104), a particular rendering method from amongst a plurality of differing candidate rendering methodologies to employ when rendering the selected content perceivable to the end user at the personally portable apparatus. (As used herein, the expression “candidate” will be understood to refer to selections that are genuinely and substantively presently available for selectable use.) In many cases, this can simply comprise automatically selecting the previously inferred rendering modality. In other cases (where, for example, the inferred rendering modality is not precisely supported by the personally portable apparatus) this can comprise automatically selecting an available rendering modality that best comports with the nature and kind of inferred rendering modality as was identified in step 104.

By one approach, if desired, this plurality of different candidate rendering methodologies can comprise different ways of presenting a same substantive content. As one illustrative example in this regard, textual content can be presented as viewable, readable text using one rendering methodology or as audible content when using a different rendering methodology. In either case, whether presented visually to facilitate the reading of this text or when presented aurally by a spoken presentation of that text, the substantive content of that text remains the same.

By another approach, and again as desired, this plurality of different candidate rendering methodologies can comprise, at least in part, a range of ways to render the selected content that extend from a rich presentation modality of the selected content to a highly abridged presentation modality of the selected content. As one illustrative example in this regard, a given presentation can comprise both graphic elements (such as pictures, photographic content, or the like) and textual elements. In this case, a first rich presentation modality can comprise a complete visual presentation of all of this content while a second abridged presentation modality can comprise a visual presentation of only the textual content to the exclusion of the graphic elements.

Another example in this regard would be to convert a voice mail to text (using a speech-to-text engine of choice) when operating in a high ambient noise scenario (or, if desired, rendering the content in both forms, i.e., playback of the voice mail in audible form as well as displaying the content in textual form). The opposite could occur (for example, converting a textual Instant Message (IM) to audio speech) in cases where it is sensed that the end user is too far from their device to be able to read it.

So configured, those skilled in the art will recognize and appreciate that a personally portable apparatus, configured as described herein, can automatically adjust its rendering modality from time to time based upon reasonable inferences that can be drawn from information regarding the end user that does not, in and of itself, comprise a specific instruction to effect such an adjustment.

As noted earlier, this process 100 will optionally accommodate gathering information regarding ambient conditions as pertain to the personally portable apparatus and/or information regarding a present state of the personally portable apparatus. When information regarding ambient conditions is available, this step 105 can further comprise the step 106 of making this automatic selection as a function, at least in part, of the information regarding such ambient conditions. Similarly, when information regarding a present state of the personally portable apparatus is available, this step 105 can further comprise the step 107 of making this automatic selection as a function, at least in part, of the information regarding a present state of the personally portable apparatus.

Accordingly, it will be understood and appreciated that these teachings offer a highly flexible approach towards leveraging various kinds of information from which one can make reasonable inferences regarding an end user's likely preferences regarding a particular rendering modality to employ at a given time. Differing types of information as noted and/or differing kinds of information for a same type of information can be employed discretely for these purposes or can be fused as desired. This, in turn, provides great flexibility to accommodate a wide variety of control strategies and techniques.

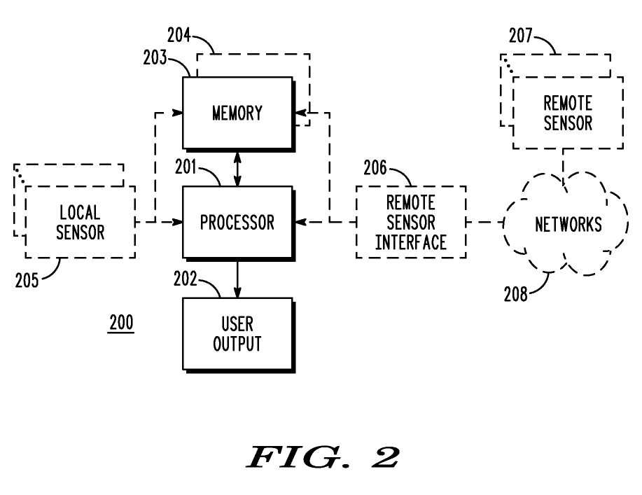

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

In this illustrative example, the personally portable apparatus 200 comprises a processor 201 that operably couples to a user output 202 and at least one memory 203. This user output 202 comprises a user output that can be dynamically configured and arranged to render selected content in a perceivable form for an end user of the personally portable apparatus 200. These teachings will readily accommodate a user output 202 that will support a plurality of differing candidate rendering modalities (including, for example, modalities that comprise different ways of presenting a same substantive content and/or a plurality of differing candidate rendering modalities that comprise, at least in part, a range of ways to render the selected content that extend from a rich presentation modality of the selected content to a highly abridged presentation modality of the selected content.

Accordingly, it will be understood that this user output 202 can comprise any or all of a variety of dynamic displays, audio-playback systems, haptically-based systems, and so forth. A wide variety of such user outputs are known in the art and others are likely to be developed in the future. Various approaches are known in the art in this regard. As these teachings are not overly sensitive to any particular selection in this regard, for the sake of brevity and the preservation of clarity, further elaboration in this regard will not be presented here.

The memory 203, in turn, has the aforementioned gathered information regarding the end user stored therein. As noted above, this comprises information that does not itself comprise specific instructions that were received from the end user via a corresponding user interface (not shown). As is also noted above, this can also comprise, if desired, information regarding a physical condition of the end user and/or information regarding physical actions taken by the end user. Furthermore, and again if desired, this memory 203 can serve to store information regarding a present state of the personally portable apparatus 200 and/or information regarding ambient conditions as pertain to the personally portable apparatus 200. The memory can also store information about user preferences, which can influence subsequent actions as per these teachings. It will also be understood that one or more of these memories can serve to store (on a permanent or a buffered basis) the selected content that is to eventually be rendered perceivable to the end user.

It will also be understood that the memory 203 shown can comprise a plurality of memory elements (as is suggested by the illustrated optional inclusion of an Nth memory 204) or can be comprised of a single memory element. When using multiple memories, those skilled in the art will recognize that the aforementioned items of information can be categorically parsed over these various memories. As one illustrative example in this regard, a first such memory 203 can store the information regarding the end user that does not comprise a specific instruction while a second such memory 204 can store information regarding the aforementioned ambient conditions. Such architectural options are well understood in the art and require no further elaboration here.

Those skilled in the art will recognize and appreciate that such a processor 201 can comprise a fixed-purpose hard-wired platform or can comprise a partially or wholly programmable platform. All of these architectural options are again well known and understood in the art and require no further description here. This processor 201 can be configured (using, for example corresponding programming as will be well understood by those skilled in the art) to carry out one or more of the steps, actions, and/or functions described herein. This can comprise, for example, configuring the processor 201 to infer from the aforementioned information a desired end user rendering modality for the selected content and to automatically select, as a function of this inferred rendering modality, a particular rendering modality from amongst a plurality of differing candidate rendering modalities to employ when rendering the selected content perceivable to the end user of the personally portable apparatus 200.

As noted earlier, some of the information used for the described purpose can be initially gleaned, at least in part, through the use of one or more corresponding sensors. To accommodate such an approach, if desired, the personally portable apparatus 200 can further comprise one or more local sensors 205 that operably couple, either directly or indirectly (via, for example, the processor 201), to one or more of the memories 203, 204. These teachings will also accommodate configuring the personally portable apparatus 200 to also comprise a remote sensor interface 206 to provide the former with access to one or more remote sensors 207. By one approach, for example, this remote sensor interface 206 can comprise a network interface (such as an Internet interface as is known in the art) that facilitates coupling to the one or more remote sensors 207 via one or more intervening networks 208 (such as, but not limited to, an intranet, an extranet such as the Internet, a wireless telephony or data network, and so forth).

Those skilled in the art will recognize and understand that such an apparatus 200 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art.

Those skilled in the art will recognize and appreciate that these teachings are readily applied in conjunction with any of a wide variety of existing end user platforms and hence can serve to significantly leverage the capabilities of a vast company of legacy equipment. These teachings are also highly scalable and can be successfully applied with a wide variety of rendering techniques and a wide variety of content types and end-user outputs.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one example in this regard, the aforementioned gathered information could comprise, at least in part, pre-programmed preferences that the user may have set. For example, setting ringer volume to “vibrate” could be linked to disabling all other audible beeps, tones, keypad clicks, and outputs. As another example in these regards, when a user enables a “lower power behavior” functionality, these teachings will readily support dimming displays, eschewing the use of status LEDs, and so forth when the available battery voltage falls below some given threshold such as 3.5V. In such a case, at least a portion of the gathered information could be gleaned, for example, by reading User Configuration/Preferences settings data as may be pre-stored in memory and/or which may be available from a corresponding remote user preferences server.

We claim:

1. A method comprising:
at a personally portable apparatus that is configured and arranged to render selected content in a perceivable form for an end user of the personally portable apparatus:
gathering information regarding the end user, wherein the information does not comprise specific instructions to the personally portable apparatus via a corresponding user interface;
inferring from the information a desired end user rendering modality for the selected content;
automatically selecting, as a function at least in part of the desired end user rendering modality for the selected content, a particular rendering method from amongst a plurality of differing candidate rendering methodologies to employ when rendering the selected content perceivable to the end user at the personally portable apparatus.

2. The method of claim 1 wherein the personally portable apparatus comprises, at least in part, a two-way wireless communications apparatus.

3. The method of claim 1 wherein the selected content comprises at least one of:
audio-visual content;
visual-only content;
audio-only content.

4. The method of claim 1 wherein gathering information regarding the end user comprises, at least in part, gathering the information using local sensors as comprise an integral part of the personally portable apparatus.

5. The method of claim 1 wherein gathering information regarding the end user comprises, at least in part, gathering the information from remote sources that do not comprise an integral part of the personally portable apparatus.

6. The method of claim 1 wherein gathering information regarding the end user comprises, at least in part, gathering information regarding physical actions taken by the end user.

7. The method of claim 1 wherein gathering information regarding the end user comprises, at least in part, gathering information regarding a physical condition of the end user.

8. The method of claim 1 wherein the plurality of differing candidate rendering methodologies comprise different ways of presenting a same substantive content.

9. The method of claim 1 wherein the plurality of differing candidate rendering methodologies comprise, at least in part, a range of ways to render the selected content that extend from a rich presentation modality of the selected content to a highly abridged presentation modality of the selected content.

10. The method of claim 1 further comprising:
gathering information regarding ambient conditions as pertain to the personally portable apparatus;
and wherein automatically selecting a particular rendering method from amongst a plurality of differing candidate rendering methodologies further comprises automatically selecting the particular rendering method as a function, at least in part, of the information regarding ambient conditions.

11. The method of claim 1 further comprising:
gathering information regarding a present state of the personally portable apparatus;
and wherein automatically selecting a particular rendering method from amongst a plurality of differing candidate rendering methodologies further comprises automatically selecting the particular rendering method as a function, at least in part, of the information regarding a present state of the personally portable apparatus.

12. A personally portable apparatus comprising:
a user output that can be dynamically configured and arranged to render selected content in a perceivable form for an end user of the personally portable apparatus:
a memory having information regarding the end user stored therein, wherein the information does not comprise specific instructions as were received from the end user via a corresponding user interface;
a processor that is operably coupled to the user output and the memory and that is configured and arranged to:
infer from the information a desired end user rendering modality for the selected content;
automatically select, as a function at least in part of the desired end user rendering modality for the selected content, a particular rendering modality from amongst a plurality of differing candidate rendering modalities to employ when rendering the selected content perceivable to the end user at the personally portable apparatus.

13. The personally portable apparatus of claim 12 wherein the personally portable apparatus comprises, at least in part, a two-way wireless communications apparatus.

14. The personally portable apparatus of claim 12 further comprising:
at least one local sensor that is operably coupled to the memory and that is configured and arranged to sense the information regarding the end user.

15. The personally portable apparatus of claim 12 further comprising:
a remote source interface that is operably coupled to the memory and that is configured and arranged to receive the information regarding the end user from remote sources that do not comprise an integral part of the personally portable apparatus.

16. The personally portable apparatus of claim 12 wherein the information regarding the end user comprises, at least in part, information regarding physical actions taken by the end user.

17. The personally portable apparatus of claim 12 wherein the information regarding the end user comprises, at least in part, information regarding a physical condition of the end user.

18. The personally portable apparatus of claim 12 wherein the plurality of differing candidate rendering modalities comprise different ways of presenting a same substantive content.

19. The personally portable apparatus of claim 12 wherein the plurality of differing candidate rendering modalities comprise, at least in part, a range of ways to render the selected content that extend from a rich presentation modality of the selected content to a highly abridged presentation modality of the selected content.

20. The personally portable apparatus of claim 12 further comprising:
a second memory that is operably coupled to the processor that that has information regarding ambient conditions as pertain to the personally portable apparatus stored therein;
and wherein the processor is further configured and arranged to automatically select a particular rendering modality from amongst a plurality of differing candidate rendering modalities by automatically selecting the particular rendering modality as a function, at least in part, of the information regarding ambient conditions.
